(19) United States
(12) Patent Application Publication
(10) Pub. No.: US 2010/0024986 A1
(43) Pub. Date: Feb. 4, 2010

(54) PERFORATING APPARATUS FOR TIRE CONSTITUENT MEMBER

(75) Inventors: Tetsuo Tatara, Osaka-shi (JP); Tomoyuki Takatsuka, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYO TIRE & RUBBER CO., LTD., Osaka-shi, Osaka (JP)

(21) Appl. No.: 12/525,771

(22) PCT Filed: Feb. 14, 2007
(86) PCT No.: PCT/JP2007/052608

§ 371 Date: Aug. 12, 2009

(51) Int. Cl. B29D 30/44

(52) U.S. Cl. 156/397

(57) ABSTRACT

The invention provides a perforating apparatus, which can efficiently form air vent holes in necessary locations on a tire constituent member and facilitates setting and changes of perforated positions to be able to readily accommodate for a change in size of the tire constituent member, and as perforating means 10, which performs a piercing action every one-time conveyance, a multiplicity of needle bodies 11 disposed on one of upper and lower sides of a feed table 5 of a band-shaped material B for the tire constituent member to be able to perpendicularly pierce the band-shaped material B on the feed table 5 are arranged in parallel in a direction of conveyance of and in a width direction of the band-shaped material B and provided to be controlled individually in respective sets, each set being composed of one or plural needle bodies 11, or each set being composed of one or plural rows of needles bodies in a width direction.

### TECHNICAL FIELD

The present invention relates mainly to a perforating apparatus for a tire constituent member such as a carcass ply material, etc.

### BACKGROUND ART

A carcass layer being one of tire constituent members of a pneumatic radial tire comprises a layer of a carcass ply material, in which reinforcement cords embedded in a rubber material and formed mainly from fiber are oriented in a radial direction of a tire, that is, a width direction, and a plurality of carcass ply materials having different widths are laminated.

Such carcass ply material is fabricated by cutting a band-shaped material for ply, in which a multiplicity of the reinforcement cords are arranged in parallel to one another, covered with a rubber material, and embedded in the rubber material, to a length corresponding to a width of the carcass ply material, truing up ply material pieces, which are cut in a manner of a oblong strip, in a manner to make cut ends constituting both widthwise ends, and successively joining the pieces at non-cut edges thereof.

In recent years, it has been proposed to cut a lengthy band-shaped material for ply to a predetermined length corresponding to that width of the carcass ply material, which is set according to a kind of and a size of a tire, while conveying the band-shaped material intermittently in a length direction, to butt the cut pieces against one another at the non-cut edges thereof on a conveyor to fabricate a carcass ply material and to supply the carcass ply material directly onto a building drum in a tire building process to build a tire (for example, JP-A-2000-141510).

By the way, in the tire building process, air pockets are liable to generate between layers of a tire constituent member such as the carcass ply material, etc. and if the air is not dispersed and building is performed to complete a tire, an influence is exerted on performances of a tire such as durability, uniformity, etc. to lead to a defective product. Therefore, air vent holes are formed on a tire constituent member, such as a carcass ply material, etc., supplied to a tire building process.

For example, JP-A-2000-301626 proposes an apparatus, in which in the course of conveying a tire constituent member, such as a carcass ply material, etc., to a tire building process, as the tire constituent member is conveyed, an elevating base provided with a perforating tool descends at the time of suspension of conveyance to form air vent holes through the tire constituent member with the use of downwardly directed needle bodies provided on the perforating tool.

With the apparatus thus proposed, the needle bodies on the perforating tool are provided to be arranged at predetermined intervals in a direction perpendicular to a direction of conveyance of the tire constituent member and all the needle bodies make a perforating motion simultaneously, whereby through-holes are formed in a lateral row at intervals, which correspond to discrete lengths of conveyance in a length direction, on the tire constituent member.

Therefore, it is necessary to make intermittent conveyance and suspension frequently according to a pitch of perforating in a length direction of the tire constituent member being a circumferential direction on a tire building drum, so that the smaller the pitch of perforating, the lower an operating efficiency.

Besides, since the needle bodies on the perforating tool are arranged at predetermined intervals and move up and down simultaneously, it is not possible to change or adjust positions of perforating in a width direction according to a kind of and a width of a tire constituent member being an object of perforating, and it is possible to exchange the perforating tool for a further perforating tool, on which needle bodies are differently arranged, in case of changing positions of perforating for the purpose of a change in size, etc.

For example, in the case where a tire constituent member is a carcass ply material, when it is demanded to form the air vent holes in a region corresponding to a neighborhood of a central portion on a built tire and a region corresponding to a neighborhood of a shoulder portion on both sides, a further perforating tool, on which needle bodies are differently arranged, is needed in order to form holes in the respective region as demanded, when the carcass ply material is changed in width in keeping with a change in tire size.
Patent Document 1: JP-A-2004-268457
Patent Document 2: JP-A-2000-301626

### DISCLOSURE OF THE INVENTION

Problems that the Invention is to Solve

The invention provides a perforating apparatus, which solves the problem described above, can efficiently and surely form air vent holes in a predetermined region demanded of a tire constituent member, which comprises a band-shaped material, while intermittently conveying the band-shaped material mainly used for the tire constituent member, such as a carcass ply material, etc., in a length direction, and can readily accommodate for a change in size of the tire constituent member. Further, there is provided a perforating apparatus, which perform perforating in a region needed in a region of a predetermined length of the band-shaped material thus cut in case of cutting the band-shaped material for the tire constituent member to a length corresponding to a width of the tire constituent member while intermittently conveying the band-shaped material, and joining the cut pieces successively at non-cut edges thereof to fabricate a tire constituent member.

### Means for Solving the Problems

The invention solves the problem described above and provides a perforating apparatus for a tire constituent member, comprising a conveyance device, which intermittently conveys a band-shaped material for the tire constituent member in a length direction by a predetermined length, a feed table, which receives the band-shaped material conveyed by the conveyance device, and perforating means, in which a needle body pierces the band-shaped material to form a hole thereon at the time of suspension of conveyance every one-time conveyance of the band-shaped material, and wherein the perforating means is disposed on one of upper and lower sides of the feed table to support thereon a multiplicity of needle bodies, which can perpendicularly pierce the band-shaped material on the feed table, to arrange the same in a direction of conveyance of and in a width direction of the band-shaped material and to enable the same to move up and down in respective sets, each set being composed of one or plural needle bodies, and comprises means for up and down movements every respective sets, and up and down movements of the needle body or bodies for the piercing action are controlled in respective sets through the up and down movement means.

The needle body or bodies on the perforating means can also be provided to afford moving up and down in respective sets, each set being composed of one or plural rows of needles in a width direction, and to control up and down movements for the piercing action in respective sets.

With the perforating apparatus of the invention for a tire constituent member, as a band-shaped material for the tire constituent member is intermittently conveyed in a length direction by a predetermined length, piercing of the needle body or bodies on the perforating means makes it possible to form a plurality of air vent holes simultaneously in a region needed in a region of the predetermined length of the band-shaped material every one-time conveyance of the band-shaped material.

In particular, since the needle body or bodies on the perforating means are arranged in parallel in a direction of conveyance of and in a width direction of the band-shaped material and can move up and down for the piercing action in sets, each set being composed of one or plural, or each set being composed of one or plural rows of needles in a width direction, the needle body or bodies are caused to selectively move up and down in respective sets according to a length of conveyance of the band-shaped material, etc., to perform a piercing action whereby it is possible to appropriately set or change positions of and intervals of perforating and to surely form air vent holes in a predetermined region needed for the tire constituent member.

For example, selection of the needle body or bodies caused to perform a piercing action makes it possible to form air vent holes in a limited range such as a region corresponding to a neighborhood of a central portion in a tire width direction, a region corresponding to a neighborhood of a shoulder portion on both sides, etc. Besides, in the case where a length of the band-shaped material as intermittently conveyed is changed due to a change in size of the tire constituent member, selection of the needle body or bodies caused to move up and down in respective sets is changed according to the length whereby it is possible to change positions of perforating so as to set the same in a region being optimum for the tire constituent member, thus enabling readily accommodating for a change in size of the tire constituent member, etc.

In the perforating apparatus for a tire constituent member, the conveyance device holds a tip end side of a band-shaped material for a tire constituent member on the feed table to intermittently convey the same by a predetermined length, which is set according to a width dimension of the tire constituent member, and comprises a cutting device, which cuts a portion of the predetermined length on a tip end side of the band-shaped material thus conveyed every one-time conveyance of the band-shaped material by the conveyance device, and a cutting process of the band-shaped material, which is provided to enable carrying out a cut piece, thus cut, of the predetermined length to a fabrication part of the tire constituent member, the perforating means is provided to enable performing perforating in a position, in which the portion of the predetermined length of the band-shaped material stops until being conveyed to a position for cutting on the feed table.

In this case, as the band-shaped material for a tire constituent member is cut to a predetermined length set according to a width dimension of the tire constituent member, it is possible to form air vent holes in a region of a portion of the predetermined length in a position, in which the portion of the predetermined length of the band-shaped material stops until being conveyed to a position for cutting on the feed table. Therefore, it is possible to join cut pieces of the band-shaped material thus cut at non-cut edges thereof to make use of the same in case of forming a tire constituent member such as a carcass ply material, etc.

In the perforating apparatus, preferably, the conveyance device can hold a tip end side portion of the band-shaped material from an upper surface side thereof to convey the same to a position for cutting on the feed table, the perforating means is disposed below a position, in which the conveyance device holds the band-shaped material for conveyance, and provided so that the needle body or bodies perform a piercing action while the conveyance device holds the band-shaped material from an upper surface side thereof. Thereby, perforating can be surely accomplished by piercing of the needle body or bodies from under in a state, in which the band-shaped material is held.

Also, preferably, the conveyance device comprises a moving body, which reciprocates between in a position, in which the band-shaped material is held for conveyance, and a position for cutting at a destination of conveyance, along the feed table, and holding means supported on the moving body to enable moving up and down, the holding means includes a holding-down plate, which contacts with the band-shaped material on the feed table when descending, and is provided to enable holding a portion of the predetermined length of the band-shaped material on a lower surface of the holding-down plate, and the holding-down plate is provided with a through-hole or holes, through which the needle body or bodies can extend when the band-shaped material is held in a held position for the conveyance. Thereby, perforating can be accomplished, with no problem, by causing the needle body or bodies on the perforating means to pierce the band-shaped material also in a state, in which the holding means holds the band-shaped material in a manner to hold down the same.

Also, through-holes, through which the needle bodies can extend, are provided in rows in positions corresponding to the arrangement of the needle bodies on the feed table opposed to the perforating means whereby the needle bodies moving up and down can be caused to pierce the band-shaped material on the feed table with no problem.

In the perforating apparatus, preferably, the needle body or bodies on the perforating means comprise one having a needle tip, from which a pointed end is removed and which is rounded. That is, even when the band-shaped material is one used for a carcass ply material, etc., comprising a rubber material, in which reinforcement cords formed from fiber are embedded, the perforating work can be favorably performed without a fear that piercing of the needle body or bodies damages or cuts the reinforcement cords.

Further, preferably, the needle bodies on the perforating means are arranged in a zigzag-shaped manner to be made alternately offset in position in a width direction every row in the width direction. In this case, it is possible to form holes on the band-shaped material in a zigzag-shaped arrangement and to set intervals, at which the needle body or bodies are arranged, that is, intervals of perforating as viewed in a direction of conveyance of the band-shaped material.

### Effect of the Invention

With the perforating apparatus of the invention for a tire constituent member, while a band-shaped material for the tire constituent member is intermittently conveyed by a predetermined length, it is possible to form a plurality of air vent holes simultaneously in a region needed in a region of the predetermined length of the band-shaped material. In particular, needle bodies in a necessary location or locations are caused to perform a perforating action in sets each composed of one or plural, or in sets each composed of a single row or plural rows of needles in a width direction, whereby positions of perforating can be appropriately set or changed, so that it is possible to surely form air vent holes in locations in a region necessitated in use of a tire constituent member and it is also possible to readily accommodate for a change in length, over which the band-shaped material is intermittently conveyed, in keeping with a change in size of the tire constituent member.

Also, the perforating apparatus according to the invention is combined with a cutting device of a band-shaped material for a tire constituent member in a process, in which the band-shaped material is cut to a predetermined length corresponding to a width of the tire constituent member and cut pieces thus cut are carried out to a fabrication part of the tire constituent member such as a carcass ply material, etc., whereby it is possible to surely perform perforating in necessary locations in a region of a predetermined length thus cut, that is, in a region necessitated in use of a tire constituent member being fabricated.

### BEST MODE FOR CARRYING OUT THE INVENTION

Subsequently, a mode for carrying out the invention will be described on the basis of an embodiment shown in the drawings.

FIG. 1 is a schematic, plan view showing an outline of the whole of a perforating apparatus, according to the invention, for a tire constituent member, FIG. 2 is a schematic, front view showing the outline, and FIG. 3 is a side view showing the outline as viewed from a supply part side of a band-shaped material. An embodiment as shown shows a perforating apparatus constructed in combination with a cutting device, which cuts a band-shaped material to a predetermined length in the case where a tire constituent member is fabricated from the band-shaped material.

A carcass ply material C being a kind of a tire constituent member is obtained by cutting a band-shaped material B for ply to a length corresponding to a width W of the carcass ply material C on a building drum in a tire building process, truing up cut pieces b, which are cut in a manner of a oblong strip, in a manner to make cut ends constituting both widthwise ends, and successively joining the cut pieces at non-cut edges thereof as shown in FIG. 11. The band-shaped material B used for fabrication of the carcass ply material C is made lengthy and band-shaped by arranging a multiplicity of reinforcement cords, which are formed mainly from fiber, in parallel to one another to cover the same with a rubber material, and band-shaped to have a predetermined width, for example, a width of 5 to 30 cm, preferably, 10 to 30 cm. Of course, it is possible to use a band-shaped material having a width outside the range described above.

A perforating apparatus A according to the invention is provided in a part of a cutting process, in which the band-shaped material B for ply (referred simply below to as band-shaped material) is cut to a predetermined length while being conveyed intermittently and carried out to a fabrication part 50 of the carcass ply material C, and combined with a cutting device 30, which serves as cutting to a predetermined length set according to a width dimension W of the carcass ply material C, to perform perforating on a portion corresponding to the predetermined length as cut.

The perforating apparatus A is provided with a supply part 1, which holds the lengthy band-shaped material B in a drawable manner, a feed table 5, which forms a forwarding part for the band-shaped material B drawn from the supply part 1, a conveyance device 20, which intermittently conveys the band-shaped material B, drawn onto the feed table 5, a predetermined length set according to the width dimension W of the carcass ply material C, that is, a predetermined length corresponding to the width dimension W by a predetermined length along the feed table in a length direction, and perforating means 10, which forms holes on the band-shaped material B when conveyance of a portion corresponding to the predetermined length stops. With the embodiment as shown, a cutting device 30 is further provided to cut a portion, corresponding to the predetermined length on a tip end side of the band-shaped material B being conveyed intermittently, in a manner of a oblong strip. The character b in the figure indicates a cut piece as cut in a manner of a oblong strip.

While a detailed explanation is omitted, the supply part 1 for the band-shaped material B is set so that a cart 2 supporting a wound body of the band-shaped material B as wound normally in a roll can draw the band-shaped material B. The feed table 5 is mounted substantially horizontally on a base frame 6 and provided at an end thereof on a supply side with a guide 7, which is downwardly bent to receive the band-shaped material B. The feed table 5 is structured to be separated into a first table 5a on the supply side and a second table 5b extending forward in a feed direction and provided so that the band-shaped material B can be cut in a separated region between the both tables 5a, 5b by the cutting device 30 in a manner described later.

The conveyance device 20 serves to hold a tip end side portion of the band-shaped material B, drawn onto the feed table 5, in a position on the first table Sa from an upper surface side to intermittently convey the same a predetermined length, which is set according to the width dimension W of the carcass ply material C being a tire constituent member, by a predetermined length as described above, and is constructed, for example, in the following manner.

As shown in FIGS. 1 to 3, moving means 21 such as a ball screw mechanism rotationally driven by a servomotor, or the like is arranged along the feed table 5 and is provided with a moving body 22, which is moved along the feed table 5 by the moving means 21. Further, holding means 23 capable of holding that portion on a tip end side of the band-shaped material B on the feed table 5, which corresponds to the predetermined length, is supported on the moving body 22 through a cylinder device 24 to enable moving up and down, and the moving body 22 moves in a state, in which the holding means 23 holds that portion on the tip end side of the band-shaped material B on the first table 5a, which corresponds to the predetermined length, whereby the portion corresponding to the predetermined length is conveyed onto the second table 5b and then the holding means releases holding of the band-shaped material B to return to an original position.

While the holding means 23 suffices to enable holding a tip end side portion of the band-shaped material B on the feed table 5, the embodiment shown is constructed to make use of suction means as shown in FIGS. 4 and 5. The holding means 23 comprises a lower plate part 25a, which abuts against the band-shaped material B on the feed table 5 when being lowered by the cylinder device 24, and an upper plate part 25b, between which and the lower plate part 25a a multiplicity of suction nozzle bodies 26 are arranged lengthwise and breadthwise and supported, and suction parts 27 exposed to a lower surface of the lower plate part 25a are provided at tip ends of the nozzle bodies 26. The respective nozzle bodies 26 are brought together into one and connected to suction means 29, such as vacuum device, etc., through a flexible tube 28 to enable the band-shaped material B to be drawn to and held on the lower surface of the lower plate part 25a. The operation of the suction means 29 is controlled to conveyance of the band-shaped material B and a returning action to the original position.

The perforating means 10 is provided below either of a position, in which the band-shaped material B is held on the first table 5a of the feed table 5 for the purpose of conveyance by the conveyance device 20, and a position for cutting on the second table 5b being a destination of conveyance, preferably, below a held position on the first table 5a as in the embodiment as shown, that is, a position, in which the predetermined-length portion of the band-shaped material B stops before being carried to a position on the second table 5b for the purpose of cutting.

With the perforating means 10, a multiplicity of needle bodies 11, which protrude above the first table Sa through through-holes 8 provided in positions on the first table 5a to correspond to the needle bodies 11 to enable piercing the band-shaped material B perpendicularly in a state, in which the holding means 23 of the conveyance device 20 pressingly holds the predetermined-length portion of the band-shaped material B on the first table 5a as shown in FIGS. 4 and 5, are arranged at necessary intervals in a direction (length direction) of conveyance of and a width direction of the band-shaped material B in a region corresponding to the predetermined length in a zigzag-shaped arrangement as shown in FIG. 6 and supported to enable moving up and down, so that a multiplicity of vent holes can be formed in a region of the predetermined length of the band-shaped material B thus cut as described above.

While the through-holes 8 are provided to serve as guiding when the needle bodies 11 protrude above, they can be made a slot, which enables a plurality of needle bodies 11 to pass through the through-holes 8 at a time. Also, holes 9, through which the needle bodies 11 can extend, are provided in positions corresponding to the respective needle bodies 11 of the perforating means 10 disposed below when the band-shaped material B is held on the first table 5a, are provided on the holding means 23 of the conveyance device 20 to enable perforating by the needle bodies 11 in a state, in which the band-shaped material B is held by the holding means 23 as described above.

With the invention, the respective needle bodies 11 of the perforating means 10 are supported to enable moving up and down in respective sets, each set being composed of one or plural, in particular, preferably, in respective sets, each set being composed of a single row or plural rows in a width direction, for example, each set being composed of two rows of needles as shown in the figure, means for up and down movements every set is provided, and up and down movements for the piercing action of the needle bodies 11 are controlled in respective sets through the means for up and down movements. That is, the needle bodies 11 disposed in positions corresponding to a region as necessitated in use as the carcass ply material C according to a length of the predetermined-length portion of the band-shaped material B being an object of perforating, for example, a region C1 corresponding to a neighborhood of a central portion of the carcass ply material C in a width direction as shown in FIG. 10, and a region C2 corresponding to a neighborhood of shoulder portions (including portions extending from the shoulder portions to side portions) are provided to enable moving up and down individually.

As the means for moving the needle bodies 11 individually in the set, in the embodiment as shown, the needle bodies 11 in respective sets, each set being composed of a single row or plural rows of needles (two rows of needles in the case shown in the figure) arranged in a width direction and at intervals in a length direction (direction of conveyance of the band-shaped material) of the feed table 5, are fixed to and supported on support bases 12 in an upright state in a manner to be made perpendicular to an upper surface (a surface bearing the band-shaped material) of the feed table 5 as shown in FIGS. 4 to 6, the support bases 12 in respective sets are respectively connected to one or a plurality of cylinder devices 13 intended for up and down movements and mounted on the base frame 6, and the cylinder devices 13 in respective sets are actuated to enable moving the needle bodies 11 up and down in respective sets.

The cylinder devices 13 for up and down movements of the needle bodies 11 are operatively controlled every set in a selective manner by a signal from a control part (not shown) to move the needle bodies 11 up and down in sets, whereby up and down movements of the needle bodies 11 in a perforating operation are controlled appropriately and selectively according to setting of a length (a length set according to a width dimension of a tire constituent member) of conveyance of the band-shaped material B being an object of perforating.

In case of moving the needle bodies 11 up and down in sets, each set being composed of one or plural, one needle body 11 or plural needle bodies 11 in respective sets are respectively fixed to and supported on the support bases in an upright state, the support bases are provided to be moved up and down by the actuation of the cylinder devices, and the actuation of the cylinder devices is individually controlled every set by a signal from the control part, whereby up and down movements of the needle bodies 11 in respective sets can be controlled. In particular, in this case, it is possible to control up and down movements of the needle bodies 11 in a set composed of one or plural of arranged in the width direction.

While the respective needle bodies 11 in the perforating means 10 can be appropriately set in diameter and length in view of strength, durability, a perforating action, etc., they are set to, for example, a diameter of 1.0 to 4.0 mm and a length of 50 to 100 mm since there is caused a problem in terms of strength when they are too thin and lengthy. In particular, as shown in enlarged scale in FIG. 8, a needle body having a needle tip 11a, from which a pointed end is removed and which is rounded, is preferable whereby it is possible to form holes on even one having therein reinforcement cords, which are formed from fiber, like the band-shaped material B used for the carcass ply material C without a fear of damaging or cutting the reinforcement cords.

As fixation means that supports the needle body 11 on the support base 12 in an upright state, as shown in FIG. 8, the support base 12 is composed of two sheets, the needle body 11 is inserted upward through a through-hole on an upper sheet 12a from under and fixed in an upright state with a flanged portion 11b at a base of the needle body 11 between the upper sheet and a lower sheet 12b, and the needle body 11 can be exchanged by separating the upper sheet 12a and the lower sheet 12b from each other. Of course, fixation can be also accomplished by the use of other fixation means.

Also, the needle bodies 11 of the perforating means 10 can be arranged in linear rows, in which respective rows in the width direction are not offset in position, in addition to being arranged in a zigzag-shaped arrangement, in which positions in a width direction are alternately offset every row in a width direction as shown in FIG. 6, as viewed in plane. The zigzag-shaped arrangement shown in FIG. 6 is further preferable since intervals, at which the needle bodies 11 are arranged, as viewed in a direction of conveyance of the band-shaped material B, that is, intervals, at which perforating is performed, can be set to be small and setting of positions and intervals of perforating and modification and adjustment are enlarged in freedom. That is, in the case where intervals, at which the needle bodies 11 are arranged in the width direction, are, for example, 20 to 60 mm, an interval between the needle bodies 11 in a row and the needle bodies 11 in a subsequent row in the width direction as viewed in a direction of conveyance amounts to ½ as long as the interval of arrangement.

The cutting device 30 cuts the predetermined-length portion on a tip end side of the band-shaped material B, which is conveyed to a position on the second table 5b, perpendicularly to a length direction in a region, in which the first table 5a and the second table 5b of the feed table 5 are separated from each other, while conveyance of the band-shaped material by the conveyance device 20 every conveyance a time stops. While the cutting device 30 can adopt various constructions as far as the band-shaped material B can be cut, in the embodiment as shown, as shown in FIG. 4, a movable carriage 33, which can be moved in a direction perpendicular to a length direction of the feed table 5 by appropriate moving means 32 such as a ball screw mechanism, etc., is provided on the base frame 6, and a circular-shaped cutting blade 31 is supported on a support member 34 provided upright on the movable carriage 33 to enable rotating about an axis of the feed table 5 in the length direction, and enters upward into a separated region of the first and second tables 5a, 5b in an upwardly projecting state to cut the band-shaped material B on the feed table 5 to cut off the predetermined-length portion on the tip end side as a cut piece b in the form of a oblong strip. In addition, when cutting is performed by the cutting device 30, the conveyance device 20 is controlled so that the holding means 23 holds the band-shaped material B on the first table 5a or maintains a held state.

The reference numeral 40 denotes conveyance means that makes use of suction means, which is similar to the conveyance device 20 described above, to hold the cut piece b, thus cut, in the form of a oblong strip, the conveyance means 40 being provided to carry out the cut piece b onto a conveyor 51 of the fabrication part 50 of a tire constituent member such as the carcass ply material C, etc. When the band-shaped material B is to be cut, the conveyance means 40 preferably holds a tip end side portion of the band-shaped material B on the second table 5b as shown by chain lines in FIG. 7, because cutting can be performed while restricting movements of the band-shaped material B.

An explanation will be given to an operating state, in which the perforating apparatus A according to the embodiment is used to form air vent holes H in a region of a predetermined length of the band-shaped material B thus cut, in a process, in which as the band-shaped material B for ply is conveyed a predetermined length corresponding to a width dimension W of the carcass ply material C being a kind of a tire constituent member, by such predetermined length, the predetermined-length portion on a tip end side is cut and the cut piece b, thus cut, in the form of a oblong strip is carried onto the fabrication part 50 of the carcass ply material C while conveyance of the band-shaped material B every conveyance a time stops.

In a preliminary work for starting of an operation, the lengthy band-shaped material B for ply is drawn out onto the feed table 5 from the supply part 1, a portion on a tip end side thereof is set in a predetermined position on the first table 5a on a supply side or the second table 5b for cutting, and an operation is started to perform intermittent conveyance of the band-shaped material B by the predetermined length, perforating, cutting, and carrying-out. In addition, a first one or plural cut pieces being defective in perforating or in length should be removed.

First, in a position, in which the predetermined-length portion of the band-shaped material B on the first table 5a of the feed table 5 stops, the holding means 23 of the conveyance device 20 returning from a position of a destination of conveyance to be positioned in an upper region is caused to descend, and the predetermined-length portion b1 of the band-shaped material B on the first table 5a is held by the holding means 23, for example, suction means (FIGS. 4 and 9). In this state, the needle bodies 11 on the perforating means 10 provided below the first table 5a are operatively controlled, by the cylinder devices 13, in respective sets, each set being composed of one or plural, or each set being composed of a single row or plural rows of needles in a width direction so that only the needle bodies 11 in a necessary location or locations are controlled to be selectively moved up and down to perform a perforating action, and the needle bodies 11 pierce the band-shaped material B perpendicularly through the through-holes 8 on the feed table 5 (FIG. 7) to perform perforating in a region necessitated in use as the carcass ply material C.

In case of forming the air vent holes H on for example, the carcass ply material C, which is a tire constituent member, in a region C1 corresponding to a neighborhood of a central portion in a width direction as shown in FIG. 10, and in a region C2 corresponding to neighborhoods of shoulder portions on both sides on a tire having been build, the needle bodies 11 in regions corresponding to three regions C1, C2 being in the neighborhood of the central portion and in the neighborhoods of the both shoulder portions are selected in the set to be moved up and down to perform a perforating action whereby the holes H can be formed at predetermined intervals and pitches in the respective regions.

At the time of perforating, the holding means 23 of the conveyance device 20 holds the band-shaped material B on the first table 5a whereby perforating can be favorably performed through piercing of the needle bodies 11. In particular, when the holding means 23 holds the band-shaped material B, perforating can be performed even when the band-shaped material B is not strongly pressed against the first table 5a.

Simultaneously when such perforating is completed, the cutting device 30 provided in a separated region of the first table 5a and the second table 5b of the feed table 5 operates, and the cutting blade 31 of the cutting device 30 advances into the separated region of the first table 5a and the second table 5b of the feed table 5 while rotating, whereby the predetermined-length portion b1 on the tip end side of the band-shaped material B being previously conveyed onto the second table 5b is cut in a direction perpendicular to a length direction.

When such cutting is completed, the cut piece b, thus cut, in the form of a oblong strip is held by the conveyance means 40 to be carried onto the conveyor 51 of the fabrication part 50 of the carcass ply material C. Simultaneously with this, the conveyance device 20 on the first table 5a lifts the tip end side portion of the band-shaped material B while the portion is held by the holding means 23, and the moving means 21 provided on the conveyance device 20 operates to convey the predetermined-length portion b1 to a position for cutting on the second table 5b (FIG. 9). Thereafter, the holding means 23 releases holding of the band-shaped material B, the conveyance device 20 returns to an original position on the first table 5a, a subsequent, predetermined-length portion b1 of the band-shaped material B is held in the same manner as described above, and further a tip end side portion conveyed to a position for cutting on the second table 5b is held on the second table 5b by the conveyance means 40 in the same manner as described above.

Thus, the needle bodies 11 on the perforating means 10 selectively perform a perforating operation in respective sets, each set being composed of one or plural, or each set being composed of a single row or plural rows of needles in a width direction, to carry out cutting in a desired region, further the cutting device 30 operates to cut off the predetermined-length portion b1 on the tip end side on the second table 5b, and the conveyance means 40 carries out the cut piece b, thus cut off, onto the conveyor 51 of the fabrication part 50. Thereafter, the same operation as described above is repeated. Also, on the conveyer 51, the cut pieces b being cut and carried out are successively lined up to arrange cut ends properly and non-cut edges are butt against one another to be joined together whereby the carcass ply material C is fabricated.

That is, as the band-shaped material B is conveyed intermittently by a predetermined length, perforating, cutting, and carrying-out are repeated whereby a tire constituent member can be fabricated while perforating is performed in a region of a predetermined length thus conveyed and cut.

Since in changing a built tire, or the like, the carcass ply material C being a tire constituent member, which is to be fabricated, is changed in width, etc. and in keeping with this, a cut length of the band-shaped material B, that is, a length being conveyed intermittently is changed, there is a need of changing and adjusting positions of air vent holes, which are formed thereon, according to a change in the length in a manner to position the air vent holes in a region being optimum as the carcass ply material, for example, in a region corresponding to a neighborhood of a central portion in a width direction and a region corresponding to a neighborhood of shoulder portions on both sides. At this time, by changing the needle bodies 11 being selectively moved up and down in the set, the needle bodies 11 on the perforating means 10 can be readily changed so as to set positions of perforating by the needle bodies 11 in a region necessitated in use as the carcass ply material C.

In addition, the perforating apparatus according to the invention can be embodied as in the embodiment described above in the case where perforating is performed in a region of a predetermined length in a process, in which while being conveyed intermittently by a predetermined length, the band-shaped material B for ply is cut to the predetermined length and the cut piece b, thus cut, in the form of a oblong strip is carried out to the fabrication part 50 of the carcass ply material C, can be also embodied in the same manner in a process, in which a band-shaped material for a further tire constituent member other than a carcass ply material is conveyed intermittently by a predetermined length, and can be embodied mounting the same perforating apparatus as described above and without combining with a cutting device, in a process of intermittent conveyance in the case where a tire constituent member is supplied directly to a tire building part while being conveyed intermittently.

### INDUSTRIAL APPLICABILITY

The invention can be made use of in case of forming air vent holes on various band-shaped materials of a tire constituent members such as belt, chafer, inner liner, side wall, tread rubber, etc. as well as on a carcass ply material.

### BRIEF DESCRIPTION OF THE DRAWINGS

FIG. 1 is a schematic, front view showing an outline of a perforating apparatus, according to the invention, for a tire constituent member.

FIG. 2 is a schematic, plan view showing the outline.

FIG. 3 is a side view showing the outline as viewed from a supply part side of a band-shaped material.

FIG. 4 is an enlarged, cross sectional view showing a conveyance device of a band-shaped material and a part of perforating means.

FIG. 5 is a cross sectional view showing the outline and taken along the line V-V.

FIG. 6 is a schematic, plan view showing a feed table of the perforating apparatus with a part thereof cut out.

FIG. 7 is an enlarged, cross sectional view at the time of perforating.

FIG. 8 is an enlarged, cross sectional view showing a needle body.

FIG. 9 is a cross sectional view illustrating a state, in which the band-shaped material is conveyed after the perforating and cutting.

FIG. 10 is a view illustrating positions of perforating.

FIG. 11 is a schematic view illustrating a state, in which a carcass ply material is fabricated.

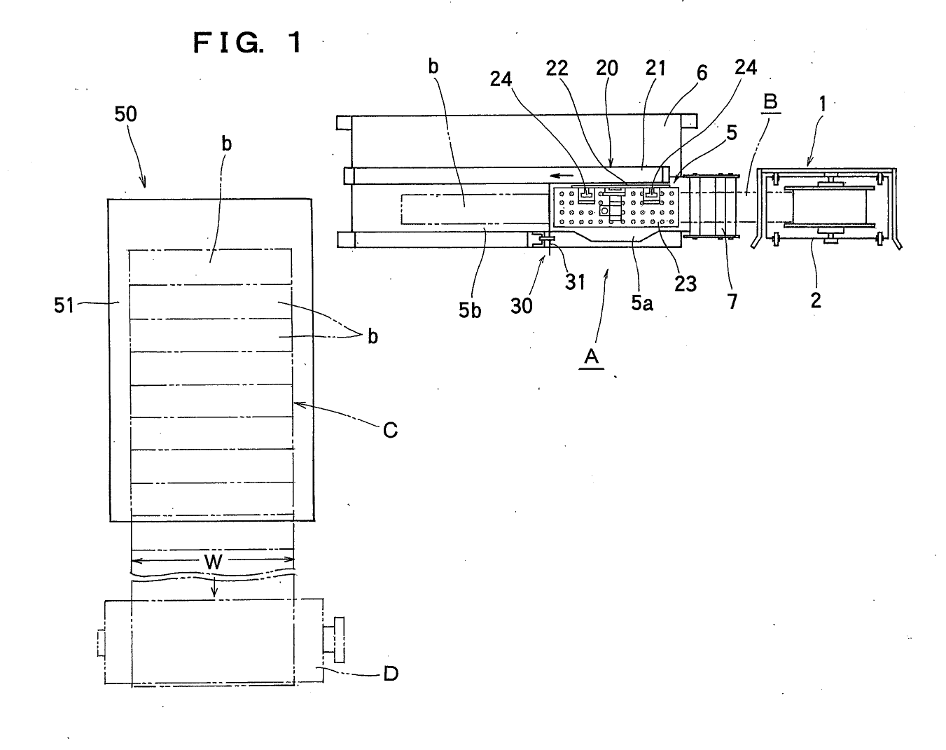

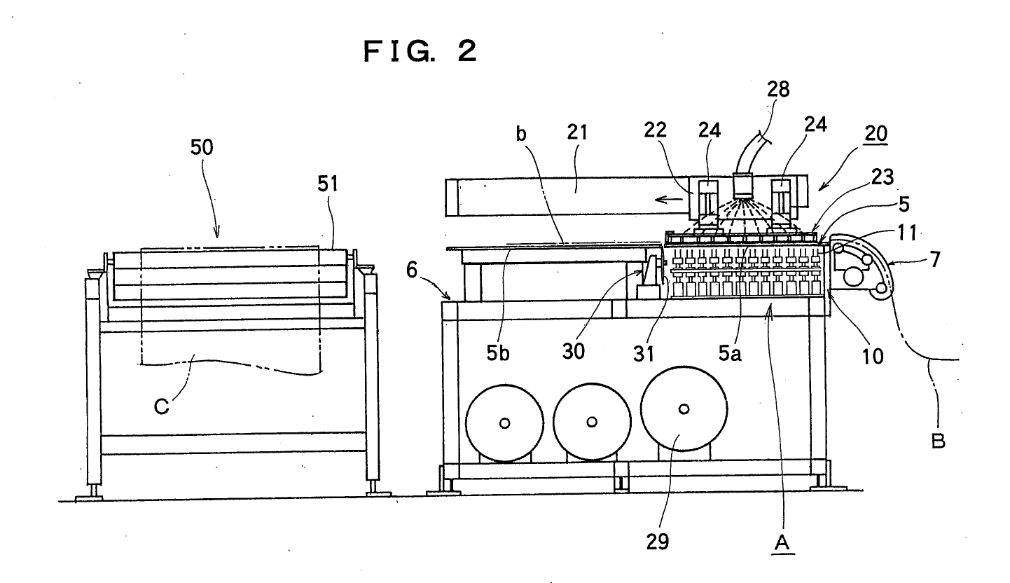

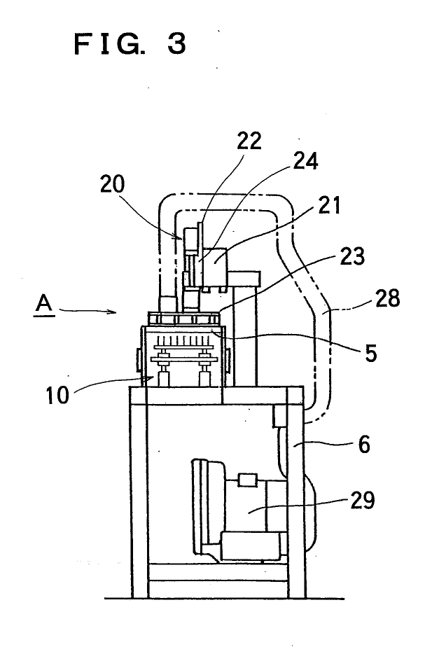

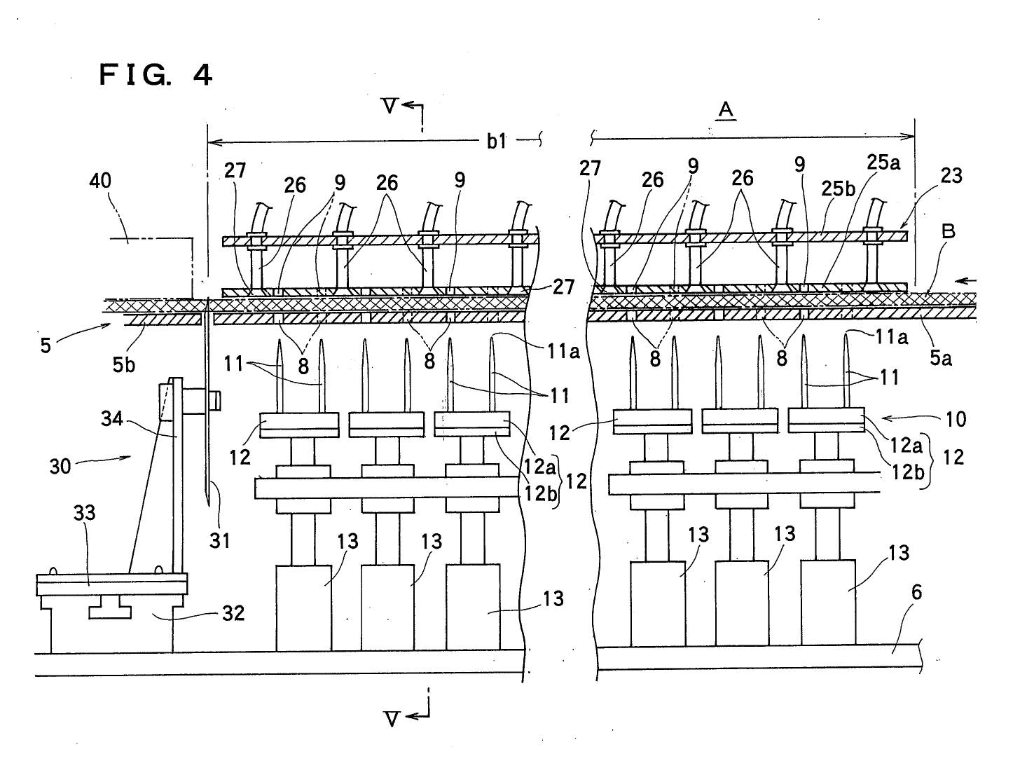

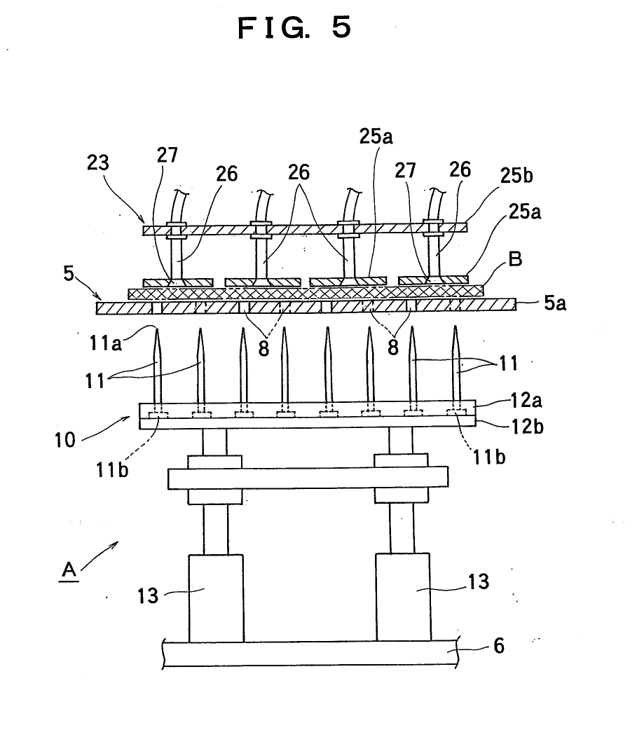

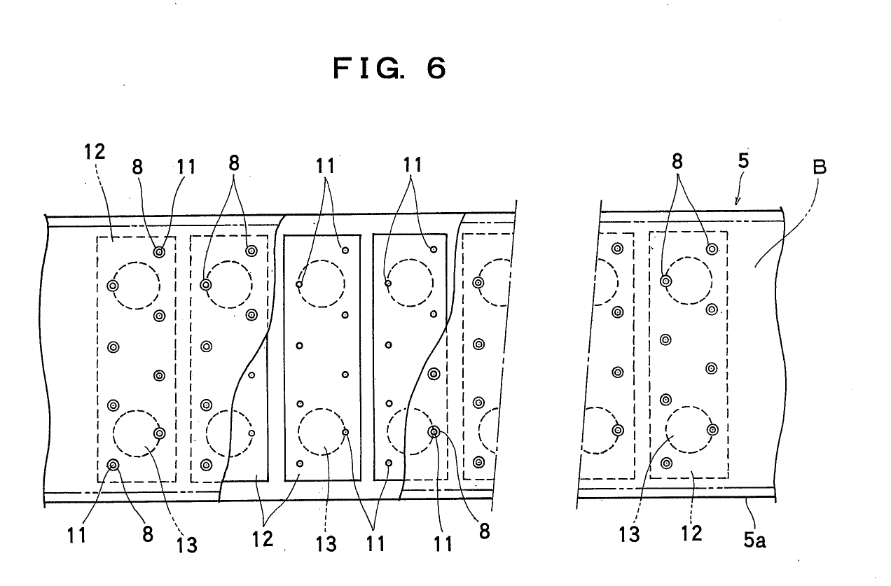

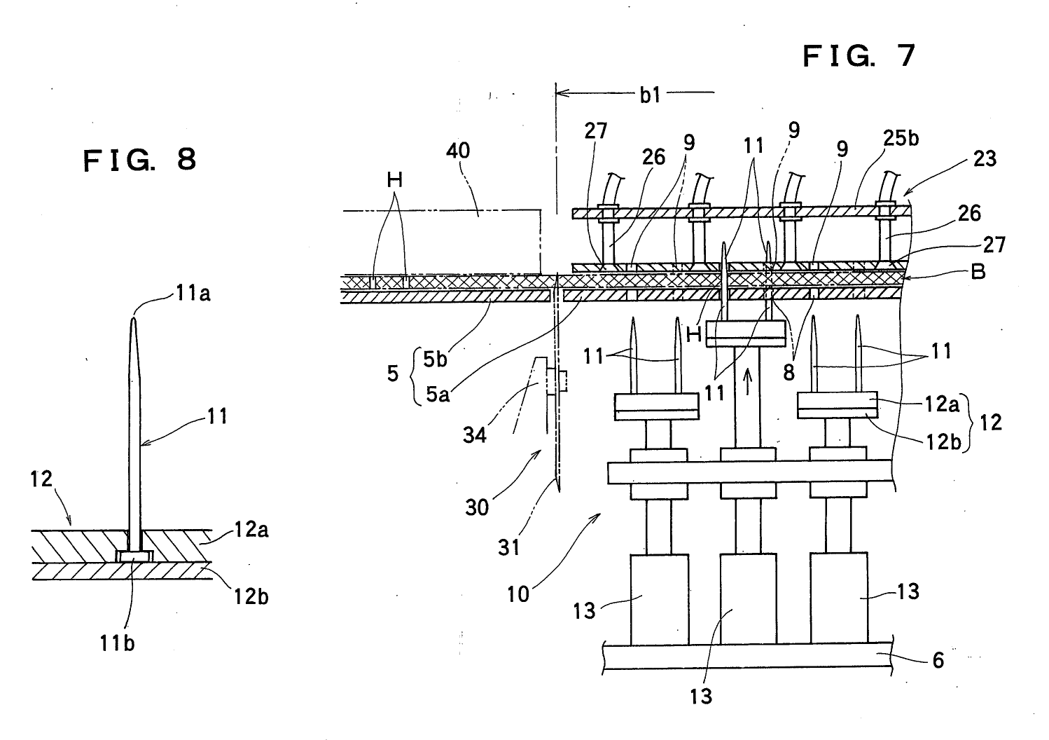

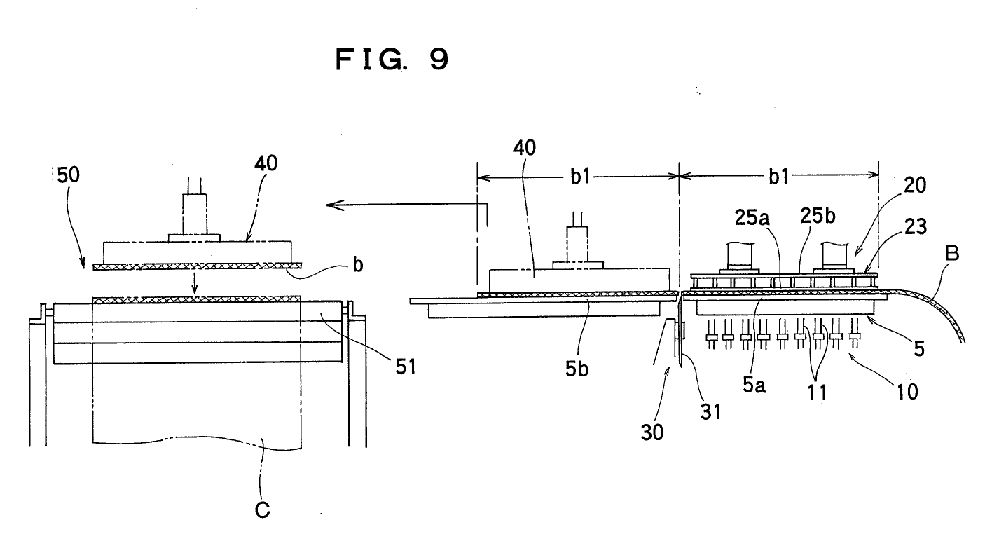

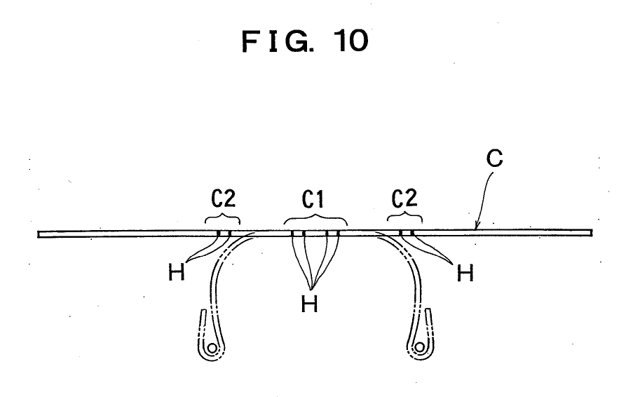

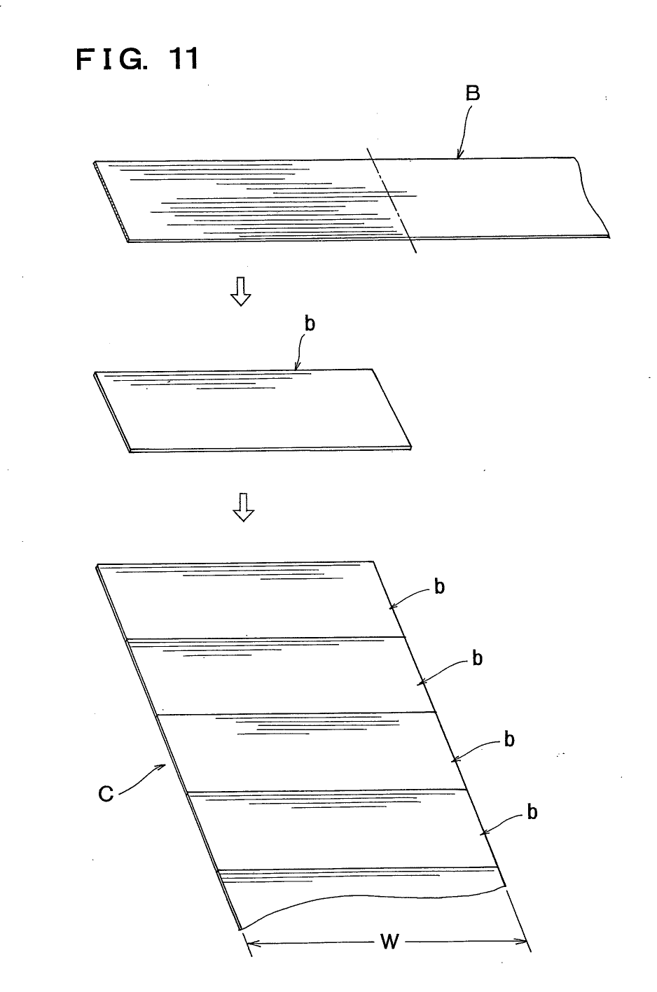

### DESCRIPTION OF REFERENCE NUMERALS AND SIGNS

A: perforating apparatus, B: band-shaped material, b: cut piece, b1: predetermined-length portion, C: carcass ply material, D: building drum, H: air vent hole, 1: supply part, 2: cart, 5: feed table, 5a: first table, 5b: second table, 6: base frame, 7: guide, 8: through-hole, 9: hole, 10: perforating means, 11: needle body, 11a: needle tip, 11b: flanged portion, 12: support base, 12a: upper sheet, 12b: lower sheet, 13: cylinder device, 20: conveyance device, 21: moving means, 22: moving body, 23: holding means, 24: cylinder device, 25a: lower plate part, 25b: upper plate part, 26: nozzle body, 27: suction part, 28: flexible tube, 29: suction means, 30: cutting device, 31: cutting blade, 32: moving means, 33: movable carriage, 34: support member, 40: conveyance means, 50: fabrication part of tire constituent member, 51: conveyor

1. A perforating apparatus for a tire constituent member, comprising a conveyance device, which intermittently conveys a band-shaped material for the tire constituent member in a length direction by a predetermined length, a feed table, which receives the band-shaped material conveyed by the conveyance device, and perforating means, in which a needle body pierces the band-shaped material to form a hole thereon at the time of suspension of conveyance every one-time conveyance of the band-shaped material, and
wherein the perforating means is disposed on one of upper and lower sides of the feed table to support thereon a multiplicity of needle bodies, which can perpendicularly pierce the band-shaped material on the feed table, to arrange the same in a direction of conveyance of and in a width direction of the band-shaped material and to enable the same to move up and down in respective sets, each set being composed of one or plural needle bodies, and comprises means for up and down movements every respective sets, and up and down movements of the needle body or bodies for the piercing action are controlled in respective sets through the up and down movement means.

2. The perforating apparatus for a tire constituent member, according to claim 1, wherein the needle body or bodies on the perforating means are supported to enable moving up and down in respective sets, each set being composed of one or plural rows of needles in a width direction, and up and down movements for the piercing action are controlled in respective sets.

3. The perforating apparatus for a tire constituent member, according to claim 2, wherein the conveyance device holds a tip end side of a band-shaped material for a tire constituent member on the feed table to intermittently convey the same by a predetermined length, which is set according to a width dimension of the tire constituent member, and comprises a cutting device, which cuts a portion of the predetermined length on a tip end side of the band-shaped material thus conveyed every one-time conveyance of the band-shaped material by the conveyance device, and a cutting process of the band-shaped material, which is provided to enable carrying out a cut piece, thus cut, of the predetermined length to a fabrication part of the tire constituent member, the perforating means is provided to enable performing perforating in a position, in which the portion of the predetermined length of the band-shaped material stops until being conveyed to a position for cutting on the feed table.

4. The perforating apparatus for a tire constituent member, according to claim 3, wherein the conveyance device can hold a tip end side portion of the band-shaped material from an upper surface side thereof to convey the same to a position for cutting on the feed table, the perforating means is disposed below a position, in which the conveyance device holds the band-shaped material for conveyance, and provided so that the needle body or bodies perform a piercing action while the conveyance device holds the band-shaped material from an upper surface side thereof.

5. The perforating apparatus for a tire constituent member, according to claim 4, wherein the conveyance device comprises a moving body, which reciprocates between in a position, in which the band-shaped material is held for conveyance, and a position for cutting at a destination of conveyance, along the feed table, and holding means supported on the moving body to enable moving up and down, the holding means includes a holding-down plate, which contacts with the band-shaped material on the feed table when descending, and is provided to enable holding a portion of the predetermined length of the band-shaped material on a lower surface of the holding-down plate, and the holding-down plate is provided with a through-hole or holes, through which the needle body or bodies can extend when the band-shaped material is held in a held position for the conveyance.

6. The perforating apparatus for a tire constituent member, according to claim 1, wherein through-holes, through which the needle bodies can extend, are provided in rows in positions corresponding to the arrangement of the needle bodies on the feed table opposed to the perforating means.

7. The perforating apparatus for a tire constituent member, according to claim 1, wherein the needle body or bodies comprise one having a needle tip, from which a pointed end is removed and which is rounded.

8. The perforating apparatus for a tire constituent member, according to claim 1, wherein the needle bodies are arranged in a zigzag-shaped manner to be made alternately offset in position in a width direction every row in the width direction.
